(19) United States
(12) Patent Application Publication
(10) Pub. No.: US 2009/0308310 A1
(43) Pub. Date: Dec. 17, 2009

(54) Driveway protector

(76) Inventor: Dino Marino, Jackson, NJ (US)

Correspondence Address: ARTHUR M. PESLAK, ESQ.;MANDEL & PESLAK, LLC, SUITE 5, 80 SCENIC DRIVE, FREEHOLD, NJ, 07728-5211, US

(21) Appl. No.: 12/456,206

(22) Filed: Jun. 12, 2009

Related U.S. Application Data
(60) Provisional application No. 61/061,756, filed on Jun. 16, 2008.

(51) Int. Cl. B05B 15/04; B05C 21/00

(52) U.S. Cl. 118/504

(57) ABSTRACT

What is disclosed is a driveway protector for use in protecting a driveway from stains during the application of coating products to the outside surface of an automobile tire.

### PRIORITY CLAIM

This application claims priority to co-pending U.S. Provisional Patent Application No. 61/061,756 filed Jun. 16, 2008.

### BACKGROUND OF THE INVENTION

The present invention is directed to the field of driveway or pavement protectors. Oftentimes, people will detail their automobiles or coat the tires of automobiles with liquid solutions or coating material to maintain the shiny look of the tires in a new condition. These materials can be applied from a spray can or by use of a brush. One problem with these materials is that some of the liquid from the brush or the spray can may overshoot the tire and run down the front surface of the tire and onto the pavement or surface under the car. When that happens, the pavement or surface may be left with a hard to remove stain. The primary object of the present invention is to solve this problem by providing an easy-to-use protective device that fits under the tire so that the liquid material does not contact the pavement or driveway.

### BRIEF DESCRIPTION OF THE DRAWINGS

FIG. 1 is a front view of the present invention.

FIG. 2 is a side view of the present invention.

FIG. 3 is a perspective view illustrating the use of the present invention.

### SUMMARY OF THE INVENTION

A driveway protector for preventing stains to a driveway due to the application of coating products to the outside of an automobile tire comprising a generally rectangular flat collection device with a cut-out in the flat collection device adapted to fit around an automobile tire; and a handle connected to the generally flat collection device. whereby a user grips the handle to slide the driveway protector around the outside surface of an automobile tire.

### DETAILED DESCRIPTION OF THE INVENTION

The present invention will now be described in terms of the presently preferred embodiment thereof. The description set forth herein should not be construed as limiting the scope of the appended claims.

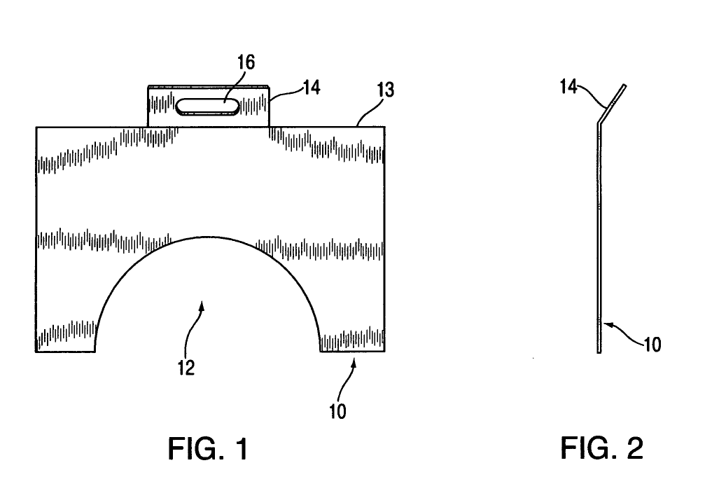

The driveway protector 10 is illustrated in the drawings. As can be seen in FIG. 1, the driveway protector 10 is generally rectangular in shape. The driveway protector 10 comprises a semi-circular cut-out 12, and a handle 14 extending from the top surface 13. The handle 14 projects from the top surface 13 at an approximate angle of 45° and comprises a second cut-out 16. It is contemplated that the driveway protector 10 can be fabricated from any suitable material such as plastic, cardboard or metal.

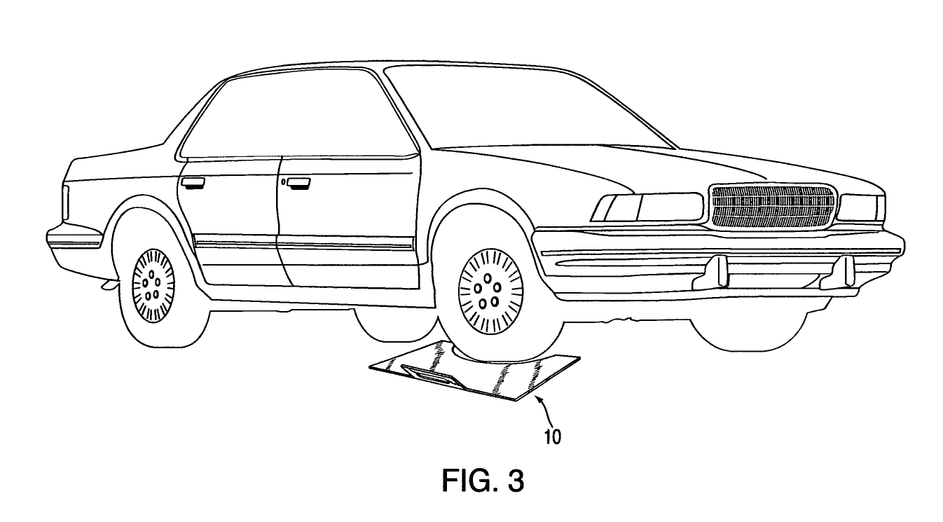

FIG. 3 illustrates the manner in which the driveway protector 10 is used in connection with an automobile tire. The driveway protector 10 is placed flat on the ground near to the automobile tire. The semi-circular cut-out 12 is adapted to fit around the tire and fit snugly thereon. In practice, the user would grip the device by means of the second cut-out 16 in the handle 14 and slide the device near the tire. The driveway protector 10 can remain in place without being held by the user. The user would then coat the outside surface of the tire with the desired liquid or spray-on material. Any drips of the coated material would be collected on the driveway protector 10. The driveway protector 10 would then be removed for cleaning.

Those of ordinary skill in the art will recognize that many obvious modifications may be made thereto without departing from the spirit or scope of the present invention as set forth in the appended claims.

What is claimed is:

1. A driveway protector for preventing stains to a driveway due to the application of coating products to the outside of an automobile tire comprising:
a. A generally rectangular flat collection device;
b. A cut-out in the flat collection device adapted to fit around an automobile tire; and
c. A handle connected to the generally flat collection device whereby a user grips the handle to slide the driveway protector around the outside surface of an automobile tire.
